(19) United States
(12) Patent Application Publication
(10) Pub. No.: US 2025/0097410 A1
(43) Pub. Date: Mar. 20, 2025

(54) EFFICIENT INTERFRAME MODE SEARCH FOR AV1 ENCODING

(71) Applicant: Meta Platforms, Inc., Menlo Park, CA (US)

(72) Inventors: Prasanth Jampani, Newark, CA (US); Jatinder Singh, Fremont, CA (US); Yunqing Chen, Los Altos, CA (US); Junqiang Lan, Fremont, CA (US); Hsiao-Chiang Chuang, Sunnyvale, CA (US)

(73) Assignee: Meta Platforms, Inc., Menlo Park, CA (US)

(21) Appl. No.: 18/467,914

(22) Filed: Sep. 15, 2023

(51) Int. Cl. H04N 19/109; H04N 19/117; H04N 19/139; H04N 19/154; H04N 19/176; H04N 19/52

(52) U.S. Cl. CPC H04N 19/109; H04N 19/117; H04N 19/139; H04N 19/176; H04N 19/52

(57) ABSTRACT

Technology herein provides a method, apparatus and computer readable storage medium for use in video encoding. The technology performs operations including pruning interframe candidate modes, based on one or more criteria, to provide a reduced set of candidate modes for encoding a video block, wherein a candidate mode includes an interframe mode type, a set of reference frame types, and one or more dynamic reference list (DRL) candidates, and wherein pruning interframe candidate modes comprises excluding one or more interframe mode types, determining a rate distortion (RD) cost for each of the candidate modes in the reduced set of candidate modes, selecting a candidate mode from the reduced set of candidate modes, based on the lowest RD cost, as a selected interframe mode, and encoding the video block using the selected interframe mode.

### TECHNICAL FIELD

Examples generally relate to video encoding technology. More particularly, examples relate to technology for efficient interframe mode search for AV1 encoding of video.

### BACKGROUND

Video compression has become increasingly important, as video has become the dominant type of data for bandwidth consumption on the Internet. In one projection, it was estimated that Internet Protocol (IP) video data would consume over 80% of the internet traffic by the end of 2022. Compression efficiency in terms of the data rate per video is one way to measure how efficient one can deliver a video to the consumers, and a key component to achieve high compression efficiency is to have an efficient video encoder. AV1 is the latest open source video codec (defining a video encoding/decoding format) developed by the Alliance of Open Media (AOM), which has shown superior coding efficiency over other modern codecs, including High Efficiency Video Coding (HEVC) and VP9. AV1 has become more widely available in industry since the finalization of the bitstream specifications for AV1 in 2018.

High compression efficiency comes with a cost of increased computational complexity. For example, a practical video encoder typically searches a set of candidate modes permitted by the bitstream specifications and finds the optimal mode using an optimization scheme. Because AV1 provides a more diverse set of coding tools and syntax elements to allow a more flexible representation of digital video content, finding an efficient AV1 encoding for the video content requires an increase in the amount of computation to perform the searching and optimization.

### SUMMARY OF PARTICULAR EXAMPLES

In some examples, a method of video encoding includes pruning interframe candidate modes, based on one or more criteria, to provide a reduced set of candidate modes for encoding a video block, wherein a candidate mode includes an interframe mode type, a set of reference frame types, and one or more dynamic reference list (DRL) candidates, and wherein pruning interframe candidate modes comprises excluding one or more interframe mode types, determining a rate distortion (RD) cost for each of the candidate modes in the reduced set of candidate modes, selecting a candidate mode from the reduced set of candidate modes, based on the lowest RD cost, as a selected interframe mode, and encoding the video block using the selected interframe mode.

In some examples, a video encoding apparatus includes a memory to store a video block, and logic communicatively coupled to the memory, the logic implemented at least partly in one or more of configurable hardware logic or fixed-functionality hardware logic, the logic to perform operations comprising pruning interframe candidate modes, based on one or more criteria, to provide a reduced set of candidate modes for encoding the video block, wherein a candidate mode includes an interframe mode type, a set of reference frame types, and one or more dynamic reference list (DRL) candidates, and wherein pruning interframe candidate modes comprises excluding one or more interframe mode types, determining a rate distortion (RD) cost for each of the candidate modes in the reduced set of candidate modes, selecting a candidate mode from the reduced set of candidate modes, based on the lowest RD cost, as a selected interframe mode, and encoding the video block using the selected interframe mode.

In some examples, at least one computer readable storage medium includes a set of instructions which, when executed by a computing device, cause the computing device to perform operations comprising pruning interframe candidate modes, based on one or more criteria, to provide a reduced set of candidate modes for encoding a video block, wherein a candidate mode includes an interframe mode type, a set of reference frame types, and one or more dynamic reference list (DRL) candidates, and wherein pruning interframe candidate modes comprises excluding one or more interframe mode types, determining a rate distortion (RD) cost for each of the candidate modes in the reduced set of candidate modes, selecting a candidate mode from the reduced set of candidate modes, based on the lowest RD cost, as a selected interframe mode, and encoding the video block using the selected interframe mode.

### BRIEF DESCRIPTION OF THE DRAWINGS

The various advantages of the examples will become apparent to one skilled in the art by reading the following specification and appended claims, and by referencing the following drawings, in which:

FIG. 1 provides a block diagram illustrating a cloud-based video distribution system according to one or more examples;

FIG. 2A provides a diagram illustrating a conventional mode decision process flow;

FIG. 2B provides a flow diagram illustrating a process for evaluating rate-distortion costs for a candidate interframe mode;

FIG. 3 provides a diagram illustrating a mode decision process flow according to one or more examples;

FIGS. 4A-4E provide diagrams illustrating interframe candidate mode pruning techniques according to one or more examples;

FIG. 5 provides a flow diagram illustrating a method of video encoding according to one or more examples;

FIG. 6 provides a block diagram illustrating an architecture for a computing system for use in AV1 video encoding according to one or more examples; and

FIGS. 7A-7B provide block diagrams illustrating a semiconductor apparatus for AV1 video encoding according to one or more examples.

### DESCRIPTION OF EXAMPLES

The improved technology as described herein provides a more efficient video encoding scheme for AV1 video encoders. The technology helps improve the overall performance of AV1 video encoders providing by a more intelligent encoder that determines an effective representation (best encoding mode) with less computation.

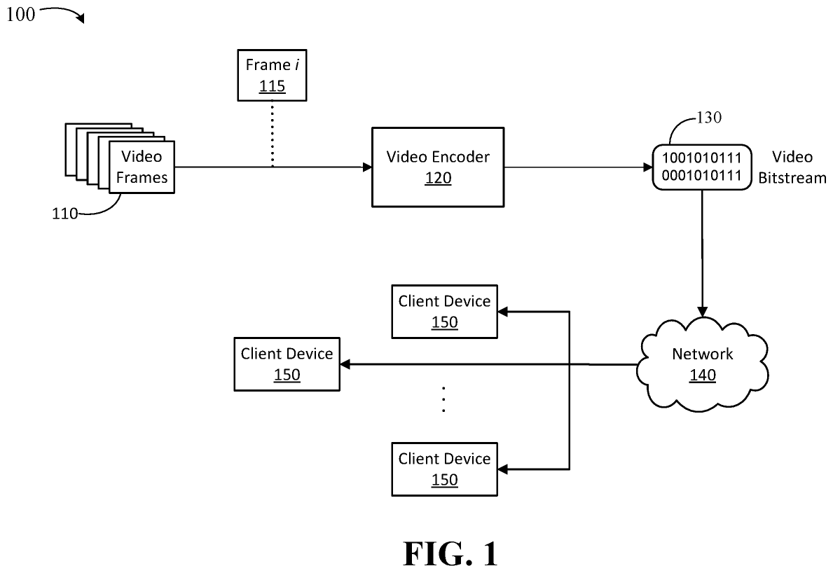

FIG. 1 provides a block diagram illustrating a cloud-based video distribution system 100 according to one or more examples, with reference to components and features described herein including but not limited to the figures and associated description. The video distribution system 100 receives and processes a series of video frames 110 (which are in unencoded form). Each video frame (i) 115 is processed by a video encoder 120 that generates a video bitstream 130, based e.g. on a video encoding format or specification. The video bitstream 130 is then streamed (transmitted) via the network 140 (cloud, e.g. the Internet) to one or more client devices 150. The client devices 150 each handle decoding of the video bitstream 130 and display of the streamed video. In some examples the video frames 110 are received in Red-Green-Blue (RGB) format, while in other cases the video frames 110 are received in a format known as the YUV format, where Y represents the brightness (i.e., luma) value and U, V represent the color (i.e., chroma) values. In some cases when video frames are received in the RGB format they are converted to the YUV format before encoding.

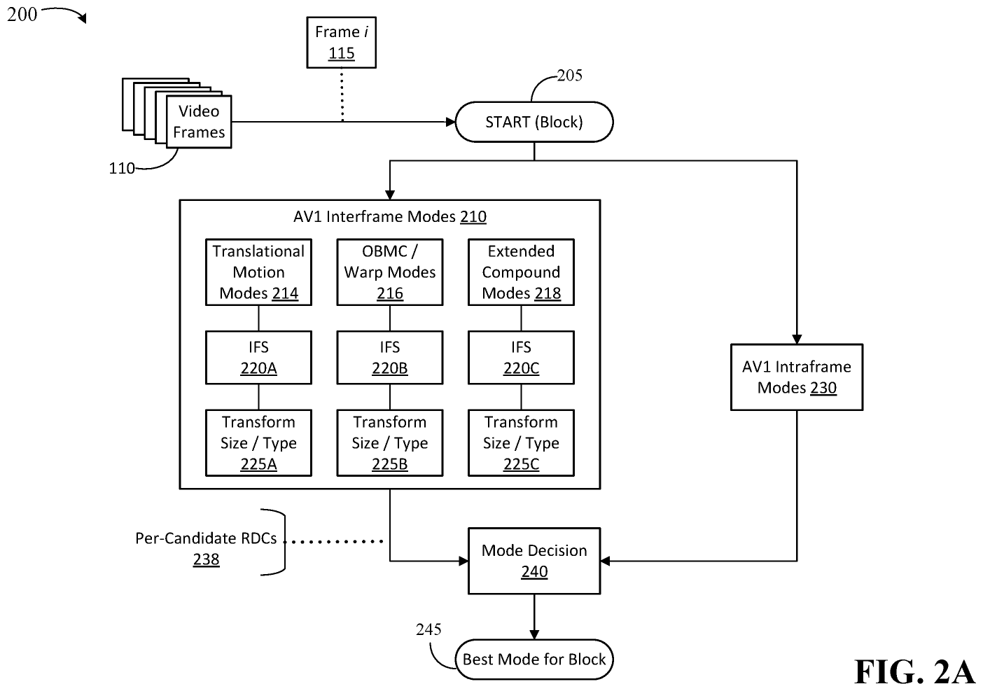

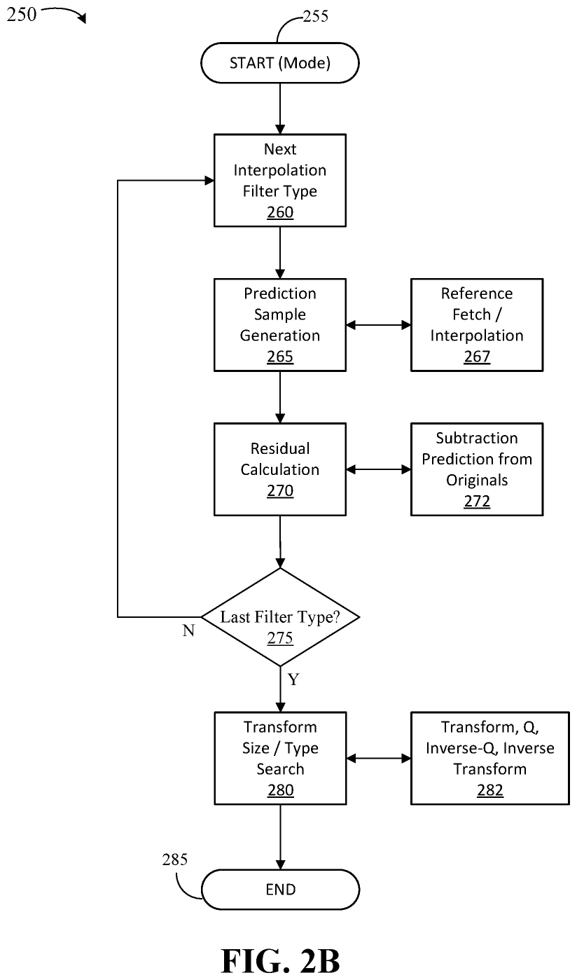

The video encoder 120 can be part of a computing system (e.g., a server), and can be implemented in hardware, software, or a combination of hardware and software. Further details regarding the video encoder 120 are provided herein with reference to FIGS. 2B, 3, 4A-4E, 5, 6, and 7A-7B.

Some or all components in the system 100 can be implemented using one or more of a central processing unit (CPU), a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, components of the system 100 can be implemented in one or more modules as a set of program or logic instructions stored in a machine- or computer-readable storage medium such as random access memory (RAM), read only memory (ROM), programmable ROM (PROM), firmware, flash memory, etc., in hardware, or any combination thereof. For example, hardware implementations can include configurable logic, fixed-functionality logic, or any combination thereof. Examples of configurable logic include suitably configured programmable logic arrays (PLAs), FPGAS, complex programmable logic devices (CPLDs), and general purpose microprocessors. Examples of fixed-functionality logic include suitably configured ASICs, combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations by the system 100 (or components thereof) can be written in any combination of one or more programming languages, including an object-oriented programming language such as Java, JavaScript, Python C#, C++, Perl, Smalltalk, or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 2A provides a diagram illustrating a conventional mode decision process flow 200 for each block of video to be encoded. As shown in FIG. 2A, the subject video frames 110 are to be encoded frame-by-frame (e.g., a video frame (i) 115, etc.) by the video encoder 120 (FIG. 1). Each frame is divided into video blocks, where, on a block-by-block basis an encoding mode is selected for use in encoding each video block. The decision process flow for each video block starts at label 205. For each video block, the video encoder evaluates a series of possible encoding modes, including evaluation, in parallel, of AV1 interframe modes via AV1 interframe mode evaluation block 210 and AV1 intraframe modes via block 230 (the AV1 intraframe mode evaluation block 230 is shown in the figure only for completeness, and will not be discussed further). Interframe modes refers to modes where the encoding of a frame is dependent on one or more other frames; intraframe modes refers to modes where the encoding of a frame is dependent only on that frame.

The process of selecting the encoding mode for a video block involves a search among candidate modes for the best mode for that video block. A mode decision module 240 selects a mode based on the evaluation of AV1 modes (e.g., based on costs associated with the modes), resulting in a best mode for encoding that video block (label 245). Rate-distortion optimization (RDO) is an efficient optimization scheme which determines the rate-distortion (RD) cost for every candidate mode associated with a set (e.g., block) of pixels. A candidate mode typically comprises a specific combination of partition type, partition size, inter/intra mode, interpolation filter type, transform size, and transform type, along with a set of reference frame types and one or more dynamic reference list (DRL) candidates, the combination of all of which determines the syntax elements of the combination. A best-effort encoder searches the same region of video pixels multiple times with different combinations of candidate modes, and the one resulting from the lowest RD cost becomes the selected mode, achieving a most cost-efficient way of representing the same set of pixels in videos. But this evaluation comes at a significant cost in terms of computational complexity.

In a given video encoder, the mode decision module 240 determines the best mode for encoding each video block, where each video block comprises a set of pixels in every frame, and the best mode poses one of the most efficient representations for this set of pixels to be reproduced in the decoder. The best mode also defines a procedure to generate a prediction for the current video block. AV1 interframe modes are evaluated in the AV1 interframe mode evaluation block 210; for illustration, the interframe modes have been organized/grouped into three categories (described in further detail below): translational motion modes 214, overlapped block motion compensation (OBMC)/warp motion modes 216, and extended compound modes 218. For interframe mode decision, several evaluation steps need to be performed to obtain the best mode:

Prediction for interframe modes: interframe mode defines the way decoders generate the prediction samples. For example, in translational modes, the decoder receives a set of motion vectors (which defines the x and y coordinates) and the associated reference frame type (which defines the temporal coordinate) to fetch the reference samples. This is repeated for each candidate mode to be evaluated.

Interpolation filter selection (IFS): once the reference samples are fetched, the mode decision module 240 needs to determine which filter to use for generating the prediction samples. There are three types of interpolation filters in AV1: (a) regular filter, (b) smooth filter, and (c) sharp filter.

Transform size and type search: after computing the residual samples from prediction samples, the encoder needs to find the best transform size and type, which can best convert the residual samples into coefficients.

For each candidate mode, reference samples are fetched, a filter is selected and a transform size/type is selected. Thus, as illustrated in FIG. 2A, for each candidate translational mode 214 the reference samples are fetched, a filter is selected (label 220A) and a transform size/type is selected (label 225A), and the RD cost 238 for that candidate is passed to the mode decision module 240. Similarly, for each candidate OBMC/Warp mode 216 the reference samples are fetched, a filter is selected (label 220B) and a transform size/type is selected (label 225B), with the RD cost 238 for that candidate being passed to the mode decision module 240, and for each candidate extended compound mode 218 the reference samples are fetched, a filter is selected (label 220C) and a transform size/type is selected (label 225C), with the RD cost 238 for that candidate being passed to the mode decision module 240.

### Complexity of AV1 Interframe Mode Decision

There are two components a typical encoder needs to calculate for the RD cost of each candidate mode: prediction and transform. Prediction refers to the prediction samples generated using motion information derived for the specific candidate mode. Transform refers to the generation of residual syntax elements using a specific combination of transform type and size. For a high-performance, RDO-based encoder, the number of rate-distortion costs (RDCs) can be employed to represent the complexity of the search process, where for one RDC computation it requires a complete loop of forward transform, quantization, inverse quantization, and inverse transform, given the specific candidate mode and transform set.

FIG. 2B provides a diagram illustrating a process 250 for evaluating potential filter and transform selections for a candidate interframe mode for a video block. The process starts at illustrated processing block 255 for a given candidate mode. At illustrated processing block 260, an interpolation filter type is selected; in subsequent passes for the candidate mode, the next interpolation filter type is selected. At illustrated processing block 265, using the selected interpolation filter type, a prediction set of samples is generated. Since the prediction can rely on samples from other video frames or video blocks, those reference samples are obtained via illustrated processing block 267 which provides for reference fetch and interpolation. Illustrated processing block 270 provides for residual calculation, which refers to subtracting the prediction from the original pixels at illustrated processing block 272.

A check to see if the last filter type has been used for the candidate mode is performed at illustrated processing block 275. If the answer is no (N), the process returns to processing block 260. If the answer is yes (Y), the process continues to illustrated processing block 280, which provides for searching for the best transform size and type. This involves, for each transform considered, performing a transform, quantizing the result, performing inverse quantization and then applying an inverse transform at illustrated processing block 282. The purpose of this series of operations at block 282 is to estimate the number of bits required to represent the residual data to obtain an accurate RDC. Thus, the transform size/type search poses the most computationally intensive portion of the process 250, as a single evaluation of transform size/type will require the full set of transform operations. The process then ends at illustrated processing block 285.

The process 250 represents part of the mode decision process flow 200 (e.g. IFS 220A, 220B and 220C in FIG. 2A and transform size/type 225A, 225B and 225C in FIG. 2A), and is useful for evaluating the rate-distortion cost. The number of RDC evaluations can be estimated as a multiplicative factor between prediction and transform. As an example, for one coding block, candidate modes may correspond to K predictions with L transforms, resulting in (K×L) RDCs. Thus, by calculating the number of predictions and transforms for candidate modes the relative complexity of AV1 interframe modes can be determined.

### Translational Motion Modes

Translational motion mode types, listed in Table 1 below, are a set of AV1 mode types involving translational motion vectors between frames, and includes all modes not characterized as OBMC, warp, or extended compound modes (as described herein). A best-effort encoder can search each of the mode types for translational motion (e.g., translational motion modes 214), following the numbers listed in Table 1. Calculating the number of predictions for each interframe mode type requires including both the number of Dynamic Reference List (DRL) candidates and the number of reference frame types. DRL is a rate-efficient method to use in conjunction with NEAR*MV and NEW*MV modes, attempting to generate a sufficiently good prediction for NEAR*MV modes, or to generate good motion predictors for NEW*MV modes, where up to N DRL candidates (e.g., N=3) can be generated for each reference frame type. The reference frame type refers to a specific combination of reference frames for both single-reference and compound modes. As shown in Table 1, there are three single-reference modes: {NEAREST_MV, NEAR_MV, NEW_MV}. Also, as shown in Table 1, there are seven compound modes: {NEAREST_NEARESTMV, NEAR_NEARMV, NEW_NEWMV, NEAREST_NEWMV, NEW_NEARESTMV, NEAR_NEWMV, NEW_NEARMV}. There are up to 7 reference frame types for single-reference modes, and up to 16 reference frame types for compound modes in AV1. Single reference modes use a single reference frame for the prediction (which can be one of the 7 reference frame types); that is, the prediction samples are generated using reference samples from one reference frame.

Compound modes, in contrast, use two reference frames for the prediction. Two reference groups are defined in the AV1 standard: group 0 contains {LAST, LAST2, LAST3, GOLDEN} reference frame types, and group 1 contains {BWDREF, ALTREF, ALTREF2} reference frame types. Reference frame types in group 0 are typically referred to video frames which have lower display order count compared to the current frame (e.g., frames coming in time before the current frame), and those in group 1 are typically referred to video frames having higher display order count (e.g., frames coming in time after the current frame). In examples the prediction samples for compound modes are generated using reference samples from both reference groups, even though the AV1 specification does not have any limitation. The average of the prediction samples between the two reference groups is used for the compound modes.

TABLE 1
Number of predictions for each candidate
mode in Translation Motion modes

| | | # | |
|---|---|---|---|
| | Number | Reference | Number |
| | of DRL | frame | of |
| Mode Type | candidates | types | predictions |
| NEAREST_MV | 1 | 7 | 7 |
| NEAR_MV | 3 | 7 | 21 |
| NEW_MV | K₁ | 7 | 7 · K₁ |
| NEAREST_{—} | 1 | 16 | 16 |
| NEARESTMV | | | |
| NEAR_NEARMV | 3 | 16 | 48 |
| NEW_NEWMV | K₂ | 16 | 16 · K₂ |
| NEAREST_NEWMV | K₃ | 16 | 16 · K₃ |
| NEW_NEARESTMV | K₄ | 16 | 16 · K₄ |
| NEAR_NEWMV | K₅ | 16 | 16 · K₅ |
| NEW_NEARMV | K₆ | 16 | 16 · K₆ |
| Total number of | 92 + 7 · K₁ + 16 · (K₂ + K₃ + K₄ + K₅ + K₆) | | |
| predictions | | | |

where K₁ . . . . K₆ represent the numbers of NEWMV candidates for each mode type, respectively. (Both NEAREST and NEAR candidates are referred to as “MVP” candidates following.) As one example, in a case where the encoder only searches one candidate for each reference frame type, making K₁ . . . . K₆ equal to 1, this results in 92+7×1+16×5=179 predictions required to evaluate all candidates for translational motion modes.

### Warp Motion and Overlapped Block Motion Compensation (OBMC) Modes

In AV1, there are two additional motion mode types supported by the codec: Warp Motion and OBMC modes. Warp Motion includes both Global and Local Warp modes, where the prediction samples are generated using a different set of filters and with finer granularity to model non-translational motions such as rotation and scaling among video frames. OBMC is a separate motion mode which combines the motion information from neighboring blocks to construct the final prediction. Both Warp Motion and OBMC modes are allowed when single-reference mode is selected (except for GLOBAL_GLOBALMV, which is a compound prediction mode), and can be used in conjunction with those interframe mode types in Table 2. As shown in Table 2, LW_MVP refers to mode(s) where motion_mode==LOCALWARP and new_mv==0 in the AV1 specification; LW_NEWMV mode refers to mode(s) where motion_mode==LOCALWARP and new_mv==1 in the AV1 specification; OBMC_MVP refers to mode(s) where motion_mode==OBMC and new_mv==0 in the AV1 specification; OBMC_NEWMV mode refers to mode(s) where motion_mode==OBMC and new_mv==1 in the AV1 specification; GLOBAL_MV mode refers to mode(s) where Ymode=GLOBALMV in the AV1 specification; and GLOBAL_GLOBALMV mode refers to mode(s) where Ymode==GLOBAL_GLOBALMV in the AV1 specification.

TABLE 2
Number of predictions for each candidate
mode in OBMC and Warp Motion modes

| | Number | # reference | |
|---|---|---|---|
| | of DRL | frame | Number of |
| Mode Type | candidates | types | predictions |
| GLOBAL_MV | 1 | 7 | 7 |
| GLOBAL_GLOBALMV | 1 | 16 | 16 |
| LW_MVP | 4 | 7 | 28 |
| LW_NEWMV | K₇ | 7 | 7 · K₇ |
| OBMC_MVP | 4 | 7 | 28 |
| OBMC_NEWMV | K₈ | 7 | 7 · K₈ |
| Total number of | 79 + 7 · (K₇ + K₈) | | |
| predictions | | | |

where typically a range for K₇ is between 5 and 13, and K₈=1. Hence, the range of total number of predictions for this category is between 121 and 177.

The number of local warp candidates occupies a large portion of the total number of interframe candidates. Specifically, local warp NEWMV candidates intend to provide a refined, extended set of candidates while they also impose complexity concerns because of the design of AV1 local warp. Prediction generation for local warp requires both online derivation of 8×8 subblock motion vectors (MVs) and interpolation given each candidate MV and, hence, introduce a long computation pipeline for each candidate. Additionally, the search of the OBMC_NEWMV MV is critical to its performance. However, it is typically architecturally prohibitive to obtain a refined MV during the mode decision stage.

### Extended Compound Modes

As discussed above, compound modes—i.e., {NEAREST_NEARESTMV, NEAR_NEARMV, NEW_NEWMV, NEAREST_NEWMV, NEW_NEARESTMV, NEAR_NEWMV, NEW_NEARMV}-refer to the candidate modes where the prediction samples are generated using reference samples from both reference groups. While the average of the prediction samples between the two reference groups is the most common technique for compound prediction, AV1 adds five additional, extended compound mode types: difference-weighted (COMPOUND_DIFFWTD), distance weighted (COMPOUND_DISTANCE), inter-inter wedge (COMPOUND_WEDGE), inter-intra wedge (interintra==1 and wedge_interintra==1 in the AV1 specification), and smooth inter-intra (interintra==1 and wedge_interintra==0 in the AV1 specification) modes. Each of these modes provides a unique way of generating the prediction by weighting the average of prediction samples from both reference groups on a per-pixel basis. Note that compound mode type specifies the spatial-temporal positions of the reference samples from the involved reference frames, and the extended compound modes further specify the method of combining the reference samples. The number of predictions for the extended compound modes is given in Table 3.

TABLE 3
Number of predictions for each candidate
mode in Extended Compound Modes

| | Number of DRL | # reference | Number of |
|---|---|---|---|
| Mode Type | candidates | frame types | predictions |
| Difference-Weighted | 4 + K₉ | 16 | 16 · (4 + K₉) |
| Comp | | | |
| Distance-Weighted | 4 + K₁₀ | 16 | 16 · (4 + K₁₀) |
| Comp | | | |
| Inter-inter wedge | 4 + K₁₁ | 16 | 16 · (4 + K₁₁) |
| Inter-intra wedge | 4 + K₁₂ | 16 | 16 · (4 + K₁₂) |
| Smooth inter-intra | 4 + K₁₃ | 16 | 16 · (4 + K₁₃) |
| Total number of | 16 · (20 + K₉ + K₁₀ + K₁₁ + K₁₂ + K₁₃) | | |
| predictions | | | |

where K₉ . . . . K₁₃ represent the numbers of the NEW_NEWMV for each of the extended compound modes. Typical values for K₉ . . . . K₁₃ are one candidate per reference frame type, and hence, the total number of RDCs becomes 16. (20+5)=400. Compound MVP candidates, including both translational modes and extended compound candidates, occupy much of the overall interframe candidates. Exhaustive search on these candidate modes is challenging in practice.

### Interpolation Filter Selection (IFS)

Interpolation Filter Selection (IFS) (e.g., as used for labels 220A, 220B and 220C in FIG. 2A) is an orthogonal technique which allows the use of the most appropriate filter type for each coding block. There are three 8-tap filters (REGULAR, SHARP, SMOOTH) to select from for block width/height greater than or equal to 8, and two 4-tap filters (REGULAR, SMOOTH) for smaller block sizes.

### Transform Type Selection

In the VP9 video coding format, there are only four transform types, based on use of the Discrete Cosine Transform (DCT) and/or the Asymmetric Discrete Sine Transform (ADST) separately for rows and columns: DCT_DCT, DCT_ADST. ADST_DCT, ADST_ADST. ADST is specifically designed to provide better adaptation to the residual statistics of intra-coded samples, and VP9 employs the DST-IV with faster butterfly implementation for ADST. The specific combination of which transform type to use is determined by the mode to be used in VP9, and hence there is no need for VP9 encoders to perform searches for transform types.

However, in AV1, the constraint on transform selection is relaxed to allow different combinations of transform types and candidate modes. Further, AV1 provides for two additional transform types: flipped ADST (FlipADST), and identity transform (IDTX). The increase in the number of transform type results in the following potential combinations of transforms (e.g., as used for labels 225A, 225B and 225C in FIG. 2A) for each dimension-horizontal (HOR) and vertical (VER)—which can provide up to 16 different combinations:

{DCT, ADST, FlipADST, IDTX}HOR×{DCT, ADST, FlipADST, IDTX}VER.

Furthermore, the transform types can be grouped into the following sets listed in Tables 4-5, where each set is a function of transform size and inter/intra mode:

TABLE 4
Sets of allowed transform types in AV1

| | | # of |
|---|---|---|
| | Allowed transform types | types |
| Set | DCT_DCT | 1 |
| 1 | | |
| Set | DCT_DCT, IDTX | 2 |
| 2 | | |
| Set | {DCT, ADST}_{HOR} × {DCT, ADST}_{VER}, IDTX | 5 |
| 3 | | |
| Set | {DCT, ADST}_{HOR} × {DCT, ADST}_{VER}, | 7 |
| 4 | IDTX, H_DCT, V_DCT | |
| Set | {DCT, ADST, FlipADST}_{HOR} × {DCT, ADST, | 12 |
| 5 | FlipADST}_{VER}, IDTX, H_DCT, V_DCT | |
| Set | {DCT, ADST, FlipADST, IDTX}_{HOR} × | 16 |
| 6 | {DCT, ADST, FlipADST, IDTX}_{VER} | |

TABLE 5
Summary of transform sets for both interframe
and intraframe transform types

| | | |
|---|---|---|
| Transform size | intraframe | interframe |

| | |
|---|---|
| >32 × 32 | Set 1 |

| | | |
|---|---|---|
| 32 × 32/32 × 16/16 × 32 | Set 1 | Set 2 |
| 16 × 16 | Set 3 | Set 5 |
| <16 × 16 | Set 4 | Set 6 |

For a given transform size, the encoder needs to decide which one combination to use of the permissible sets (per Tables 4-5). Thus, the total number of RDCs for each video block is given by the number of predictions times the number of transform types (combinations). As one example, consider 8×8 blocks (transform size is 8×8). From Tables 4-5, there are 16 possible transform combinations for interframe modes, thus for each interframe mode the encoder needs to decide which one combination to use out of the 16 possible combinations. As discussed above the number of predictions required to evaluate all candidates for interframe modes can be at least:

$$179 ( predictions for translational motion modes ) + 121 ( predictions for OBMC / Warp modes ) + 400 ( predictions for extended compound modes ) = 700 total number of predictions per video block$$

Hence for this example the total number of RDCs is the multiplication of the number of predictions (700) times the number of transform types (16) which requires 11,200 RDCs with a brute-force encoder to code a single 8×8 video block. As illustrated by this one example, it is computationally prohibitive for practical encoders to search this many combinations, given the constraints of performance, power, and silicon area.

Accordingly, the improved technology described herein provides for an intelligent AV1 encoder that prunes candidate interframe modes using a variety of pruning techniques to reduce the number of computations as part of the mode search and, thus, provide a more efficient encoding scheme while retaining the robustness present in the AV1 codec. As described in more detail below, the pruning techniques can be grouped into three classes.

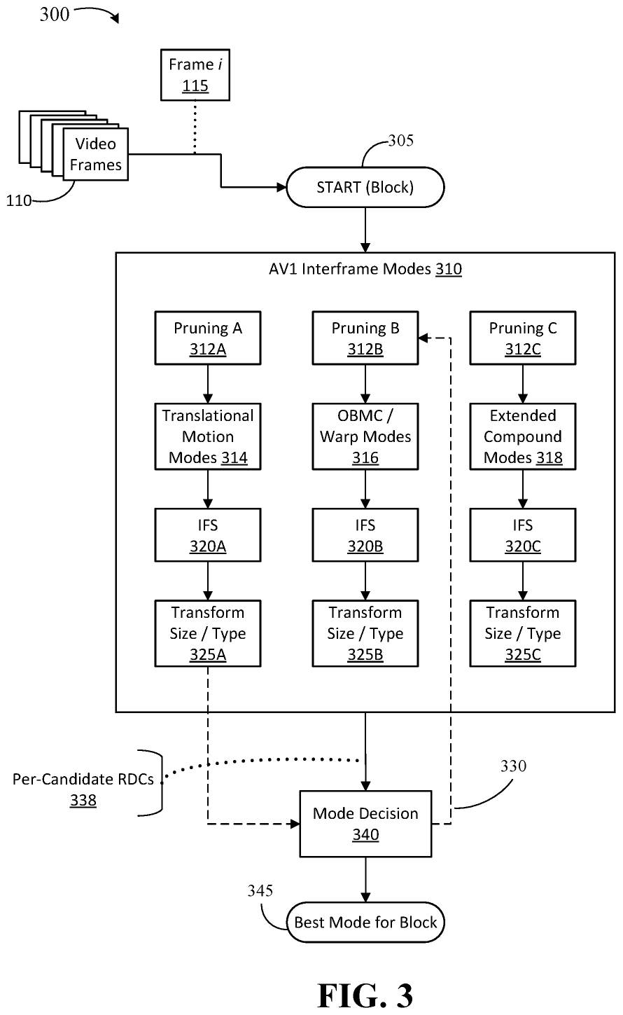

FIG. 3 provides a diagram illustrating a mode decision process flow 300 according to one or more examples, with reference to components and features described herein including but not limited to the figures and associated description. The mode decision process flow 300 is applied for each block of video to be encoded. As shown in FIG. 3, the subject video frames 110 are to be encoded frame-by-frame (e.g., a video frame (i) 115, etc.) by the video encoder 120 (FIG. 1). Each frame is divided into video blocks, where, on a block-by-block basis an encoding mode is selected for use in encoding each video block. RDO (as discussed above with reference to FIG. 2A) is an efficient optimization scheme which determines the RDC for candidate modes associated with a set (e.g., block) of pixels.

The decision process flow for each video block starts at label 305. For each video block, a series of possible encoding modes are evaluated in parallel, including AV1 interframe modes (evaluated in the AV1 interframe mode evaluation block 310) and AV1 intraframe modes (not shown in FIG. 3). The process of selecting the encoding mode for a video block involves pruning certain candidate modes and conducting a search among the remaining candidate modes for the best mode for that video block. Pruning of interframe candidate modes comprises excluding one or more interframe mode types based on one or more criteria (e.g., rules), and provides a reduced set of candidate interframe modes for encoding a video block. Each candidate interframe mode includes an interframe mode type, a set of reference frame types, and one or more dynamic reference list (DRL) candidates. By pruning the number of interframe mode candidates, the total number of RDCs is reduced.

According to examples, the AV1 interframe mode evaluation block 310 illustrated in FIG. 3 includes a series of pruning steps-including pruning class A (312A), pruning class B (312B), and pruning class C (312C). Based on the pruning, there can be up to three categories of AV1 interframe modes remaining for evaluation: translational motion modes 314, OBMC/warp motion modes 316, and extended compound modes 318. Each remaining candidate mode is evaluated via the filter/transform search process described herein with reference to FIG. 2B, and the RD cost 338 for each candidate is passed to a mode decision module 340.

Thus, as illustrated in FIG. 3, for each candidate translational mode 314 the reference samples are fetched, a filter is selected (label 320A) and a transform size/type is selected (label 325A), and the RD cost 338 for that candidate is passed to the mode decision module 340. Similarly, for each candidate OBMC/Warp mode 316 the reference samples are fetched, a filter is selected (label 320B) and a transform size/type is selected (label 325B), with the RD cost 338 for that candidate being passed to the mode decision module 340, and for each candidate extended compound mode 318 the reference samples are fetched, a filter is selected (label 320C) and a transform size/type is selected (label 325C), with the RD cost 338 for that candidate being passed to the mode decision module 340.

The mode decision module 340 selects a mode based on the evaluation of AV1 modes (e.g., selecting a mode based on lowest RD cost associated with the candidate modes), resulting in a best mode (most cost-efficient way) for encoding that video block (label 345)—while avoiding, based on pruning of candidate modes, a significant portion of the calculations required for searching for best modes. In some examples, RD cost information from searching translational motion modes is provided as feedback via path 330 to inform pruning decisions for Pruning class B (pruning for OBMC/warp modes).

Thus, for the video encoder mode search, the mode decision module 340 determines the best mode for encoding each video block, where each video block comprises a set of pixels in every frame, and the best mode poses one of the most efficient representations for this set of pixels to be reproduced in the decoder. The best mode also defines a procedure to generate a prediction for the current video block.

The process 300 can generally be implemented in the video encoder 120 (FIG. 1, already discussed). More particularly, the process 300 and/or functions performed by the video encoder 120 can be implemented as one or more modules as a set of logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out the process 300 and/or functions associated with the video encoder 120 can be written in any combination of one or more programming languages, including an object-oriented programming language such as Java, JavaScript, Python C#, C++, Perl, Smalltalk, or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

### Pruning Techniques

According to examples, pruning techniques as described herein are used to reduce the number of interframe candidates searched for best mode searching for AV1 video encoding. Pruning class A (see 312A in FIG. 3) refers to techniques for pruning translational motion modes (translational motion modes are listed in Table 1 herein). Pruning class B (see 312B in FIG. 3) refers to techniques for pruning OBMC/warp modes (OBMC/warp modes are listed in Table 2 herein). Pruning class C (see 312C in FIG. 3) refers to techniques for pruning extended compound modes (extended compound modes are listed in Table 3 herein). Some techniques are applicable to more than one pruning class (e.g., pruning translational motion modes and extended compound modes, or pruning all categories of interframe modes-translational motion modes, OBMC/warp modes and extended compound modes). Some techniques reduce potential modes searched, even if not reducing or excluding specific candidate mode types.

### 1. Pruning of Specific Interframe Candidate Types

A first suite (suite 1) of pruning techniques reduces or excludes candidate modes based on the specific mode types, as listed in the following sets of example rules.

Set 1.1 (included in Pruning classes A and C): Exclude one or more types of candidate modes (including extended compound mode types) involving certain compound modes. These mode types can be excluded based on different criteria, such as described in the example rules below.

1.1.a: As one example, exclude N candidate mode types identified as being the least useful—i.e., having the lowest utility. A subset of compound mode types can be identified as mode types having the lowest utility of the translational motion mode types (e.g., lowest usefulness in terms of compression efficiency). For instance, the subset of compound mode types having the lowest utility of the translational motion mode types can include these mode types: {NEAREST_NEWMV, NEW_NEARESTMV, NEAR_NEWMV, NEW_NEARMV}. Where N=4 and the subset of compound mode types having the lowest utility includes the mode types {NEAREST_NEWMV, NEW_NEARESTMV, NEAR_NEWMV. NEW_NEARMV}, all four of these mode types would be excluded. This technique is analogous to excluding mode types based on ranking (e.g., ranked or ordered list) where the mode types are ranked or ordered based on utility.

1.1.b: As another example, exclude candidate mode types having a maximum motion vector (MV) difference less than a threshold T_{MV}. The threshold T_{MV} can be programmable. Determine the sum of absolute differences (SAD) between the resulting MVs and the MVs from preceding MVP candidates, including {NEAREST_NEARESTMV, NEAR_NEARMV} (NEAREST_NEARESTMV and NEAR_NEARMV are referred to herein as “regular compound modes”), and compare the SADs. If the maximum difference is less than T_{MV}, the candidate mode type can be excluded. Note that SAD refers to the normalized sum of absolute differences per pixel (e.g., dividing by the block size). This technique excludes some modes from searching where the results would not be much different from other modes.

1.1.c: As another example, exclude candidate mode types having a prediction difference from original greater than a threshold T_{P}. The threshold T_{P} can be programmable. Generate predictions of each of these modes, then sort the SAD between the source and the predictions (i.e., sum of absolute residual samples based on subtracting the predictions from the originals). Then for RDC search, only search the candidate modes whose SAD values are less than T_{P}. Similarly, the sum of absolute transform difference (SATD) can be used as the distortion metric (instead of SAD) with the same setting. Note that both SAD and SATD refer to the normalized metrics per pixel (e.g., dividing by the block size). This technique also excludes some modes from searching where the results would not be much different from other modes.

Set 1.2 (included in Pruning class C): Exclude one or more types of candidate modes in the extended compound mode types. Extended compound mode types can be excluded based on different criteria, such as described in the example rules below.

1.2.a: As one example, exclude all of the candidate modes in the extended compound mode types (e.g., as having lower utility). This technique is analogous to excluding mode types based on ranking (e.g., ranked or ordered list) where the mode types are ranked or ordered based on utility and the extended compound mode types are among the lower ranked/ordered mode types.

1.2.b: As another example, exclude all candidate modes in the extended compound mode types based on a prediction difference from originals between single vs. compound modes, with an ordered RDC calculation of single-reference modes followed by compound modes. Calculate the SAD values (i.e., sum of absolute residual samples) for the regular compound modes. If the associated SAD value is greater than a scaling factor S multiplied by the minimum SAD values for the other single-reference modes, then exclude the search of extended compound modes. S can be a programmable scaling factor.

1.2.c: As another example, exclude N extended compound mode types according to an ordered list. N can be chosen, e.g., to reduce the complexity of calculations required, and the list can be ordered based on complexity. For example, if the extended compound mode types are ordered as in the following list: {difference-weighted compound, inter-inter wedge, smooth inter-intra, inter-intra wedge, distance-weighted compound}, then if N=2, the last two candidate types (e.g., inter-intra wedge, distance-weighted compound) would be excluded.

1.2.d: As another example, exclude candidate modes in the extended compound mode types based on a prediction difference between extended compound modes and regular compound modes. Calculate the SAD values (i.e., sum of absolute residual samples) for the extended compound modes. Exclude the search of those extended compound modes where the associated SAD value is greater than a scaling factor S multiplied by the minimum SAD values of a prediction mode for the regular compound modes. S can be a programmable scaling factor. SATD can be used as a metric instead of SAD.

1.2.e: As another example, exclude candidate modes in the extended compound mode types based on a ranked prediction difference. Calculate the SAD values (i.e., sum of absolute residual samples) for the extended compound modes, and rank by SAD value. Exclude those candidates ranked highest on the list (e.g., search only candidates with the lowest K SAD values as ranked). SATD can be used as a metric instead of SAD.

1.2.f: As another example, exclude candidate modes in the extended compound mode types based on ranking by SAD value—that is, by combining a ranking by SAD value with each of Rules 1.2.b-1.2.e—and excluding candidate modes based on a prescribed number from the ranked/ordered list (e.g., only permitting searching of R modes from the ranked/ordered list). This example technique resolves the situation where multiple extended compound modes result in the same SAD values (e.g., in any of Rules 1.2.b-1.2.c).

### 2. Pruning of Reference Frame Types, DRL Index, and Local Warp Candidates

A second suite (suite 2) of pruning techniques reduces or excludes candidate modes based on the reference frame types, DRL index, and local warp candidates, as listed in the following sets of example rules.

Set 2.1 (included in Pruning classes A, B and C): Exclude candidate modes based on reducing the number of reference frames to perform motion estimation (ME) and mode decision (MD), such as described in the example rules below. Reducing the number of reference frame types for each candidate mode is one way for an encoder to more efficiently search relevant interframe modes with lower complexity.

2.1.a: As one example, reduce the number of reference frames to N (e.g., from 7 to 4) for both ME and MD, e.g. by employing {LAST. LAST2} for reference group 0 and {BWDREF, ALTREF2} for reference group 1.

2.1.b: As another example, rank reference frames based on the quantization index values (“qindex”) of the reference frames and select the N (e.g., out of 7) reference frames (e.g., 4 references when N=4) with the lower quantization indices. In case two or more references have the same qindex values, then choose 2 references from each reference group.

2.1.c: As another example, rank reference frames based on both the qindex (see Rule 2.1.b) and the distances between the current frame and the respective reference frame in display order (i.e., the POC (picture order count) distance). For example, a ranking score can be defined for each reference frame as:

$$Score = w \vert Qc - Qr \vert + ( 1 - w ) \vert Pc - Pr \vert$$

where w is a programmable weighting factor whose value ranges between 0 and 1, (Qc, Qr) are the qindex of the current frame and the reference frame, and (Pc. Pr) are the POC numbers of the current frame and the reference frames. The N reference frames (e.g., 4 references) having the lowest score are used.

Set 2.2 (included in Pruning classes A, B and C): Exclude candidate modes based on reducing the number of DRL candidates (e.g., prune those having DRL index of 2 for both NEAR_MV and NEAR_NEARMV candidates), such as described in the example rules below.

2.2.a: As one example, limit the number of DRL candidates to R (e.g., R=2) and exclude the candidate(s) with indices greater than or equal to R. For example, if there are 3 DRL candidates {DRL[0]. DRL[1]. DRL[2]} and if R=2, then exclude DRL[2].

2.2.b: As another example, calculate the SAD of the motion vectors between the DRL candidate with an index of N (e.g., N=2) and those of the preceding candidates (e.g., motion vector differences). If the maximum SAD value is less than T_{D}, then one can exclude the calculation of RDC for this DRL candidate. SAD refers to the normalized sum of absolute difference value per pixel. T_{D} can be a programmable threshold.

2.2.c: As another example, calculate the SADs of the DRL candidates. If the SAD value (i.e., sum of absolute residual samples) of a DRL candidate with an index of N (e.g., N=2) is greater than a scaling factor S times the minimum SAD value of the other DRL candidates (e.g., prediction differences), then exclude the calculation of RDC for the specific candidate mode. S can be a programmable scaling factor.

2.2.d: As another example, if the RD cost of the NEAR_MV candidate with DRL index of N (e.g., N=2) is greater than S times the minimum RD costs of the other single-reference DRL candidates, then exclude the calculation of RDC for the NEAR_NEARMV candidate with DRL index of N (e.g., N=2). S can be a programmable scaling factor.

Set 2.3 (included in Pruning classes A, B and C): Exclude candidate modes based on fractional motion estimation (FME) costs, such as described in the example rules below. The number of combinations for NEW_NEWMV and local warp NEWMV candidates can be pruned based on a cost metric from FME.

2.3.a (included in Pruning classes A and C): As one example, use the reference frame with lowest cost from FME for each reference group to form the NEW_NEWMV candidate, and exclude other reference frames (e.g., exclude all but the reference frame with lowest FME cost).

2.3.b (included in Pruning class B): As another example, use sorted variance-based costs from FME to rank the order of the local warp NEWMV candidates based on the minimum FME costs of candidates from each reference frame. By ranking the local warp NEWMV candidates with references in the ascending order of the FME costs, RDC calculations can be performed on a subset of local warp NEWMV candidates by pruning candidates associated with references having higher costs. Similarly, SATD can be used in place of variance as the cost metric.

Some of the prior examples refer to use of a threshold (e.g., T_{MV} or T_{P} or T_{D}) or a scaling factor (e.g., S). In examples, any of the thresholds or scaling factors are determined using a training framework. As one example, a small set of training videos is encoded using a variety of values for the respective threshold or scaling factor to find the best parameter and this value is used for the encoding of future videos.

### 3. Pruning of Compound MVP Candidates Based on Ranking

A third suite (suite 3) of pruning techniques reduces or excludes candidate compound MVP modes (compound mode types based on NEAREST or NEAR) based on order ranking, as listed in the following sets of example rules. Reducing the number of compound candidate modes is another way for an encoder to more efficiently search relevant interframe modes.

Set 3.1 (included in Pruning classes A and C): Exclude candidate modes based on a predefined order ranking, given a constrained number of compound MVP candidates, such as described in the example rules below.

3.1.a: As one example, use a predefined order to rank candidate modes based on reference frame type, such as, e.g., the following predefined order:

{LAST, BWDREF} -->
{LAST, ALTREF2} -->
{LAST2, BWDREF} -->
{LAST2, ALTREF2}.

where LAST, LAST2 are in reference group 0 and BWDREF, ALTREF are in reference group 1. This provides an ordered list of candidate modes. Given a limitation on the number of candidates to search, exclude the lower-ranked candidates and only search the upper-ranked candidates.

3.1.b: As another example, use a predefined order to rank candidate modes based on reference frame closeness, such as, e.g., the following predefined order:

{N0, N1} -->
{N0, F1} -->
{F0, N1} -->
{F0, F1}

where, for this rule, N0 and N1 refer to the reference frames from each reference group which are closest to the current frame in display order, and F0 and F1 refer to the reference frames from each reference group which are farther from the current frame in display order. This provides an ordered list of candidate modes. Given a limitation on the number of candidates to search, exclude the lower-ranked candidates and only search the upper-ranked candidates.

3.1.c: As another example, use a predefined order to rank candidate modes based on reference frame qindex, such as, e.g., the following predefined order:

{L0, L1} -->
{L0, H1} -->
{H0, L1} -->
{H0, H1}

where, for this rule, L0 and L1 refer to the reference frames having lower qindex values from each reference group, and H0 and H1 refer to the reference frames having higher qindex values from each reference group. This provides an ordered list of candidate modes. Given a limitation on the number of candidates to search, exclude the lower-ranked candidates and only search the upper-ranked candidates.

3.1.d: As another example, use a predefined order to rank candidate modes based on reference frame temporal level, such as, e.g., the following predefined order:

{L0, L1} -->
{L0, H1} -->
{H0, L1} -->
{H0, H1}

where, for this rule, L0 and L1 refer to the reference frames lying in lower temporal levels from each reference group, and H0 and H1 refer to the reference frames lying in higher temporal levels from each reference group (e.g., where frames are partitioned into layers). This provides an ordered list of candidate modes. Given a limitation on the number of candidates to search, exclude the lower-ranked candidates and only search the upper-ranked candidates.

Set 3.2 (included in Pruning classes A and C): Exclude candidate modes based on dynamic order ranking of compound MVP candidates, such as described in the example rules below. By performing the RDC calculation on the single-reference candidates, the order of compound MVP candidates can be determined dynamically using the associated RDCs.

3.2.a: As one example, use a dynamically-generated order to rank candidate modes based on reference frame RD costs, such as, e.g., the following dynamically-generated order:

{best0, best1} -->
{best0, worse1} -->
{worse0, best1}-->
{worse0, worse1}

where, for this rule, best0 and best1 refer to the reference frame types of the single-reference candidate from each reference group with the lowest RD costs, and worse0 and worse1 refer to the other reference frame types from each reference group, respectively. Given a limitation on the number of candidates to search, exclude the lower-ranked candidates and only search the upper-ranked candidates.

3.2.b: As another example, use a dynamically-generated order to rank candidate modes based on reference frame RD costs, such as, e.g., the following dynamically-generated order:

{best0, best1} -->
{worse0, best1}-->
{best0, worse1} -->
{worse0, worse1}

where, for this rule (as with the previous rule), best0 and best1 refer to the reference frame types of the single-reference candidate from each reference group with the lowest RD costs, and worse0 and worse1 refer to the other reference frame types for each reference group, respectively. Given a limitation on the number of candidates to search, exclude the lower-ranked candidates and only search the upper-ranked candidates.

3.2.c: As another example, use a dynamically-generated order to rank candidate modes based on FME costs of searching compound modes to determine the ranked order of the compound MVP search. By ranking the FME costs of compound NEW_NEWMV candidates, a priority can be assigned for the compound MVP candidate of each reference frame type accordingly. The encoder can perform RDC calculation for compound MVP candidates of reference frame type in an ascending order of the FME costs of compound search. Given a limitation on the number of candidates to search, exclude the lower-ranked candidates and only search the upper-ranked candidates.

### 4. Pruning of OBMC Candidates

A fourth suite (suite 4) of pruning techniques reduces or excludes OBMC candidates, as listed in the following example rule set.

Set 4.1 (included in Pruning class B): Exclude, or reduce the number of, OBMC candidates based on the RD costs of single-reference candidates, block size or filter, such as described in the example rules below.

4.1.a: As one example, apply the motion information (motion vectors and reference frame types) of the R candidates with the lower RD cost values for performing OBMC searches, and exclude the remaining candidates, thus pruning based on the RD costs of single-reference candidates. R can be a programmable number. This pruning technique provides an example of using RD cost information from searching translational motion candidates to inform the decision on pruning OBMC candidates, per feedback path 330 (FIG. 3).

4.1.b: As another example, exclude the OBMC candidate modes for blocks with sizes greater than N×N. For instance, if N is equal to 64, then exclude candidate modes for blocks with sizes greater than 64×64 per this example.

4.1.c: As another example, exclude the IFS for blocks coded with OBMC—that is, bypass the IFS search stage—and, instead, apply the regular interpolation filter for OBMC candidates.

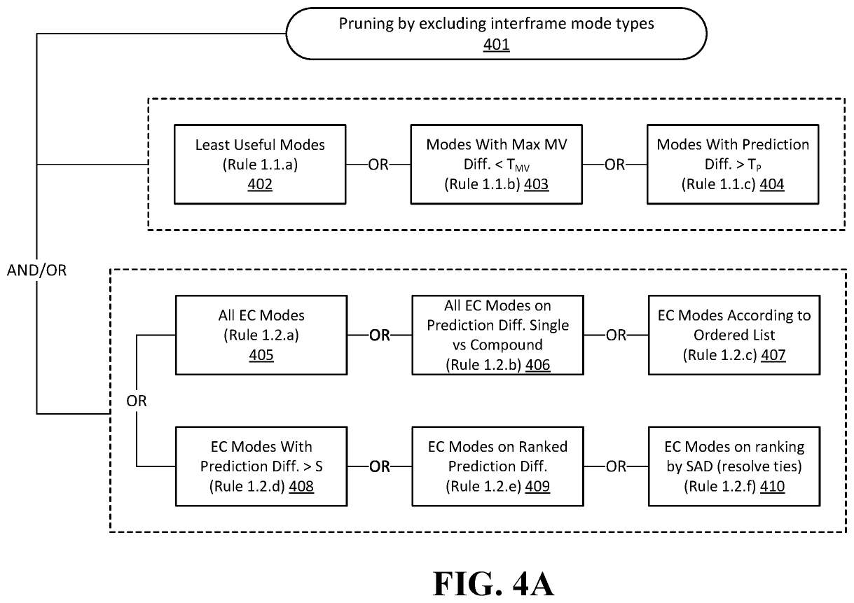

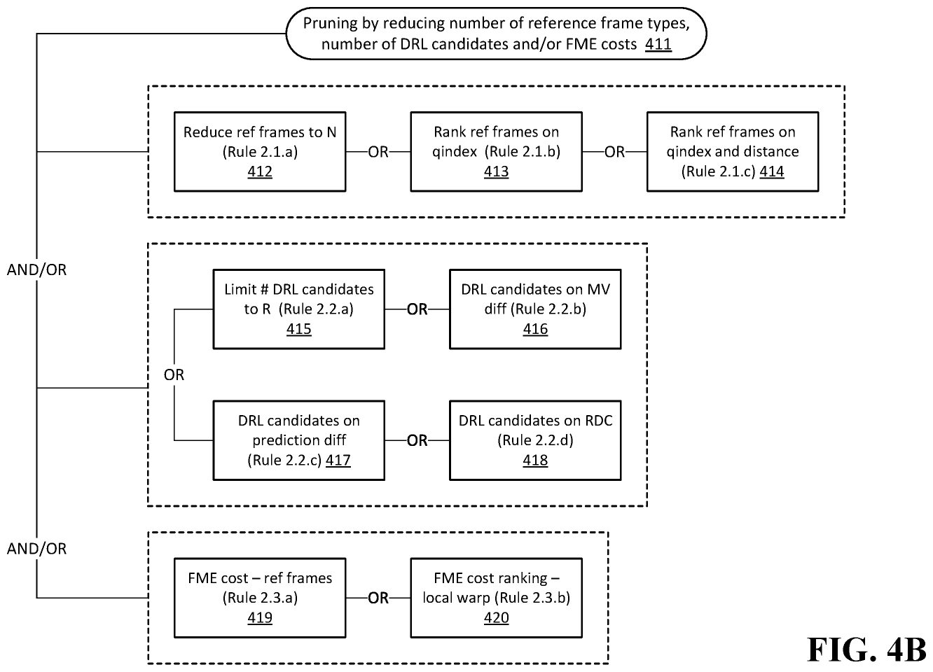

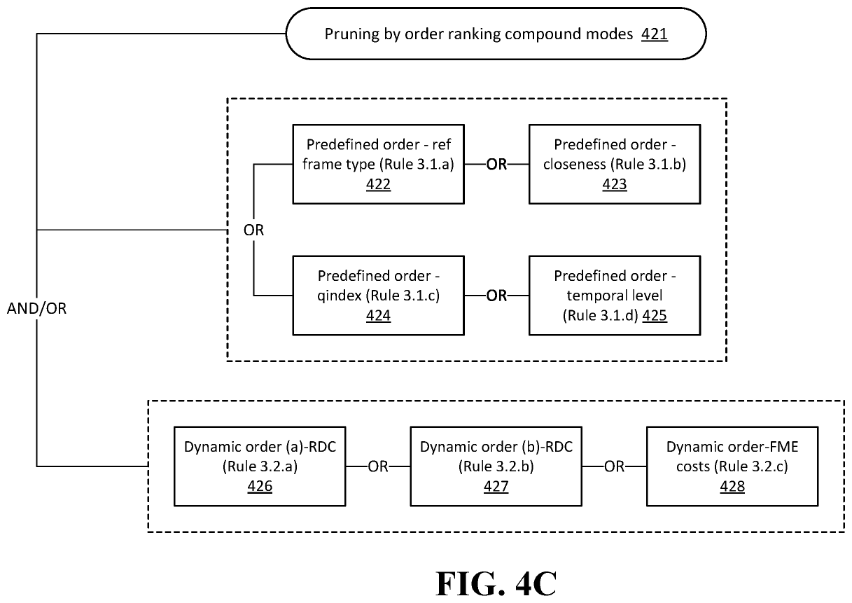

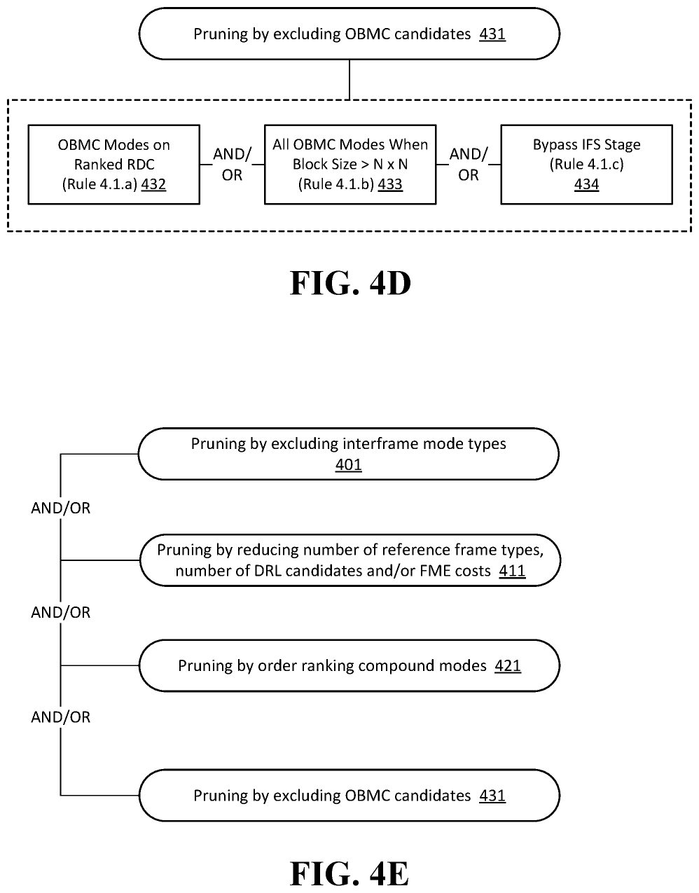

FIGS. 4A-4E provide diagrams illustrating interframe candidate mode pruning techniques (and combinations thereof) according to one or more examples, with reference to components and features described herein including but not limited to the figures and associated description. These diagrams illustrate in summary form how the pruning rules described above can be applied and combined with each other.

Turning now to FIG. 4A, provided is a diagram illustrating a summary of example pruning techniques 401 that reduce or exclude candidate modes based on the specific interframe mode types, as described herein for rules in suite 1. The pruning techniques 401 include pruning set 1.1 (exclude types of candidate modes involving certain compound modes) and/or pruning set 1.2 (exclude one or more types of candidate modes in the extended compound mode types).

Pruning set 1.1 includes rule 1.1.a for pruning the least useful modes (i.e., having the lowest utility) (label 402), rule 1.1.b for pruning modes having a maximum motion vector (MV) difference less than a threshold T_{MV} (label 403), and rule 1.1.c for pruning modes having a prediction difference greater than a threshold T_{P} (label 404). Pruning set 1.2 includes rule 1.2.a for pruning all candidate modes in the extended compound mode types (label 405), rule 1.2.b for pruning all extended compound mode types based on a prediction difference between single vs. compound modes (label 406), rule 1.2.c for pruning extended compound mode types according to an ordered list (label 407), rule 1.2.d for pruning candidate modes in the extended compound mode types based on a prediction difference between extended compound modes and regular compound modes (label 408), rule 1.2.e for pruning candidate modes in the extended compound mode types based on a ranked prediction difference (label 409), and rule 1.2.f for pruning candidate modes in the extended compound mode types based on ranking by SAD value (e.g., to resolve ties) (label 410).

Of note, in a particular application of pruning, only one of the rules in pruning set 1.1 can be used at a time (i.e., rule 1.1.a, rule 1.1.b and rule 1.1.c are mutually exclusive). Likewise, in a particular application of pruning, only one of the rules in pruning set 1.2 can be used at a time (i.e., rule 1.2.a, rule 1.2.b, rule 1.2.c, rule 1.2.d, rule 1.2.e and rule 1.2.f are mutually exclusive). However, permissible pruning rules from set 1.1 and 1.2 can be combined (i.e., any one rule from set 1.1 and any one rule from set 1.2 can be combined in the same pruning application).

Turning now to FIG. 4B, provided is a diagram illustrating a summary of example pruning techniques 411 that reduce or exclude candidate modes based on based on the reference frame types, DRL index, and/or FME costs, as described herein for rules in suite 2. The pruning techniques 411 include pruning set 2.1 (exclude candidate modes based on reducing the number of reference frames), pruning set 2.2 (exclude candidate modes based on reducing the number of DRL candidates) and/or pruning set 2.3 (exclude candidate modes based on fractional motion estimation (FME) costs).

Pruning set 2.1 includes rule 2.1.a for reducing the number of reference frames to N (e.g., from 7 to 4), (label 412), rule 2.1.b for reducing references by ranking reference frames on qindex (label 413), and rule 2.1.c for reducing references by ranking reference frames on qindex and distance (label 414). Pruning set 2.2 includes rule 2.2.a for limiting the number of DRL candidates to R (e.g., R=2) (label 415), rule 2.2.b for reducing DRL candidates based on SAD of the motion vectors between the DRL candidates (label 416), rule 2.2.c for reducing DRL candidates based on differences between SAD values (e.g., prediction differences) of DRL candidates (label 417), and rule 2.2.d for reducing DRL candidates based on RDC of single-reference DRL candidates (label 418). Pruning set 2.3 includes rule 2.3.a for pruning based on FME cost for reference frames—e.g., exclude all but lowest FME cost (label 419) and rule 2.3.b for pruning local warp candidates based on FME variance-based cost ranking (label 420).

Of note, in a particular application of pruning, only one of the rules in pruning set 2.1 can be used at a time (i.e., rule 2.1.a, rule 2.1.b and rule 2.1.c are mutually exclusive). Likewise, in a particular application of pruning, only one of the rules in pruning set 2.2 can be used at a time (i.e., rule 2.2.a, rule 2.2.b, rule 2.2.c, and rule 2.2.d are mutually exclusive). Similarly, in a particular application of pruning, only one of the rules in pruning set 2.3 can be used at a time (i.e., rule 2.3.a and rule 2.3.b are mutually exclusive). However, permissible pruning rules from set 2.1, 2.2 and 2.3 can be combined (i.e., any one rule from set 2.1, any one rule from set 2.2 and/or any one rule from set 2.3 can be combined in the same pruning application).

Turning now to FIG. 4C, provided is a diagram illustrating a summary of example pruning techniques 421 that reduce or exclude candidate compound modes based on order ranking, as described herein for rules in suite 3. The pruning techniques 421 include pruning set 3.1 (exclude candidate modes based on predefined order ranking) and pruning set 3.2 (exclude candidate modes based on dynamic order ranking.

Pruning set 3.1 includes rule 3.1.a for pruning using a predefined order to rank candidate modes based on reference frame type (label 422), rule 3.1.b for pruning using a predefined order to rank candidate modes based on reference frame closeness (label 423), rule 3.1.c for pruning using a predefined order to rank candidate modes based on reference frame qindex (label 424), and rule 3.1.d for pruning using a predefined order to rank candidate modes based on reference frame temporal level (label 425). Pruning set 3.2 includes rules 3.2.a and 3.2.b for pruning using a dynamically-generated order to rank candidate modes based on reference frame RD costs (labels 426 and 427), and rule 3.2.c for pruning using a dynamically-generated order to rank candidate modes based on rank candidate modes based on FME costs of searching compound modes (label 428).

Of note, in a particular application of pruning, only one of the rules in pruning set 3.1 can be used at a time (i.e., rule 3.1.a, rule 3.1.b, rule 3.1.c and rule 3.1.d are mutually exclusive). Likewise, in a particular application of pruning, only one of the rules in pruning set 3.2 can be used at a time (i.e., rule 3.2.a, rule 3.2.b, and rule 3.2.c are mutually exclusive). However, permissible pruning rules from set 3.1 and 3.2 can be combined (i.e., any one rule from set 3.1 and any one rule from set 3.2 can be combined in the same pruning application).

Turning now to FIG. 4D, provided is a diagram illustrating a summary of example pruning techniques 431 that reduce or exclude OBMC candidate modes, as described herein for rules in suite 4. The pruning techniques 431 include pruning set 4.1 (exclude OBMC candidate modes based on the RD costs of single-reference candidates, block size or filter). Pruning set 4.1 includes rule 4.1.a for pruning OBMC candidates based on the RD costs of single-reference candidates (label 432), rule 4.1.b for pruning OBMC candidates based on block size (label 433), and rule 4.1.c for pruning OBMC candidates based on bypassing the IFS search stage (label 434). Rules from rule set 4.1 can be combined in the same pruning application.

Turning now to FIG. 4E, provided is a diagram illustrating a summary of how the example pruning techniques can be applied or combined across suites. As shown in FIG. 4E, pruning techniques 401 (suite 1, including pruning sets 1.1 and 1.2, FIG. 4A) can be combined with pruning techniques 411 (suite 2, including pruning sets 2.1, 2.2 and 2.3, FIG. 4B), pruning techniques 421 (suite 3, including pruning sets 3.1 and 3.2, FIG. 4C), and/or with pruning techniques 431 (suite 4, including pruning set 4.1, FIG. 4D). Additionally, pruning techniques 411 (suite 2) can be combined with pruning techniques 421 (suite 3) and/or with pruning techniques 431 (suite 4). Likewise, pruning techniques 421 (suite 3) can be combined with pruning techniques 431 (suite 4).

The pruning techniques described herein (including pruning techniques 401, 411, 421 and/or 431) can generally be implemented in the video encoder 120 (FIG. 1, already discussed). More particularly, the pruning techniques described herein (including pruning techniques 401, 411, 421 and 431) can be implemented as one or more modules as a set of logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out the pruning techniques described herein (including pruning techniques 401, 411, 421 and 431) can be written in any combination of one or more programming languages, including an object-oriented programming language such as Java, JavaScript, Python C#, C++, Perl, Smalltalk, or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

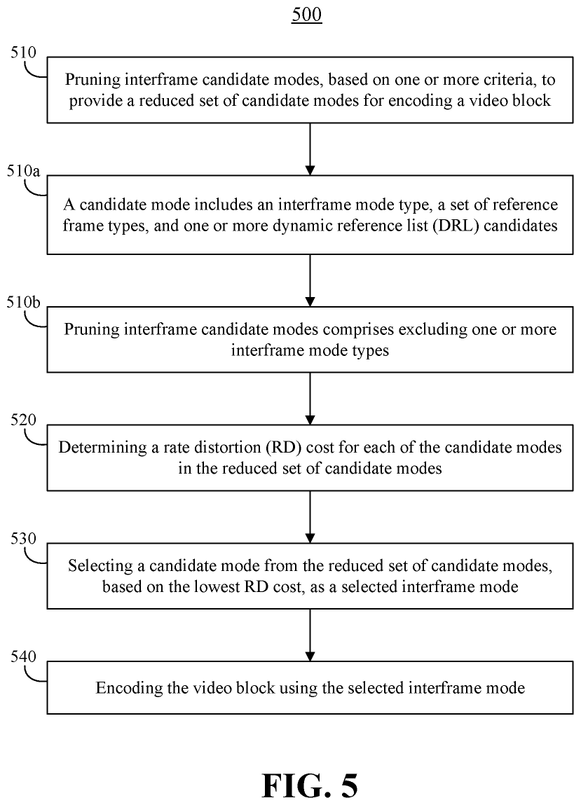

FIG. 5 provides a flow diagram illustrating a method 500 of video encoding according to one or more examples, with reference to components and features described herein including but not limited to the figures and associated description. The method 500 can generally be implemented in the video encoder 120 (FIG. 1, already discussed) and/or via components of the video distribution system 100 (FIG. 1, already discussed). More particularly, the method 500 can be implemented as one or more modules as a set of logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations shown in the method 500 and/or functions associated therewith can be written in any combination of one or more programming languages, including an object-oriented programming language such as Java, JavaScript, Python C#, C++, Perl, Smalltalk, or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 510 provides for pruning interframe candidate modes, based on one or more criteria, to provide a reduced set of candidate modes for encoding a video block, where at block 510a a candidate mode includes an interframe mode type, a set of reference frame types, and one or more dynamic reference list (DRL) candidates, and at block 510b pruning interframe candidate modes comprises excluding one or more interframe mode types. Illustrated processing block 520 provides for determining a rate distortion (RD) cost for each of the candidate modes in the reduced set of candidate modes. Illustrated processing block 530 provides for selecting a candidate mode from the reduced set of candidate modes, based on the lowest RD cost, as a selected interframe mode. Illustrated processing block 540 provides for encoding the video block using the selected interframe mode.

In examples, the criteria include those described in one or more pruning techniques as described herein with reference to pruning techniques 401, pruning techniques 411, pruning techniques 421, and/or pruning techniques 431. In some examples, a candidate mode further includes a transform size and a transform type. In some examples, pruning the interframe candidate modes further comprises one or more of reducing a number of reference frame types (e.g., as described herein with reference to rules 2.1.a-c) or reducing a number of DRL candidates (e.g., as described herein with reference to example rules 2.2.a-d).

In some examples, pruning the interframe candidate modes comprises excluding at least one interframe mode type based on an ordered list of interframe mode types (e.g., as described herein with reference to example rules 1.1.a, 1.2.a, 1.2.c, 1.2.f, 3.1.a-d, and/or 3.2.a-c). In some examples, pruning the interframe candidate modes comprises one or more of excluding at least one interframe mode type or reducing a number of DRL candidates based on a difference between two motion vectors (e.g., as described herein with reference to example rules 1.1.b and/or 2.2.b).

In some examples, pruning the interframe candidate modes comprises excluding at least one interframe mode type based on a difference between a source for the video block and a prediction for the video block, wherein the prediction is based on a respective interframe mode type (e.g., as described herein with reference to example rules 1.1.c, 1.2.b, and/or 1.2.d-e). In some examples, pruning the interframe candidate modes comprises excluding at least one interframe mode type based on one or more of RD costs for single-reference interframe candidate modes or block size for the video block (e.g., as described herein with reference to example rules 4.1.a-b).

In some examples, pruning the interframe candidate modes further comprises reducing a number of combinations based on a cost metric from fractional motion estimation (e.g., as described herein with reference to example rules 2.3.a-b and/or 3.2.c). In some examples, wherein pruning the interframe candidate modes further comprises bypassing an interpolation filter selection stage and using a predetermined filter (e.g., as described herein with reference to example rule 4.1.c).

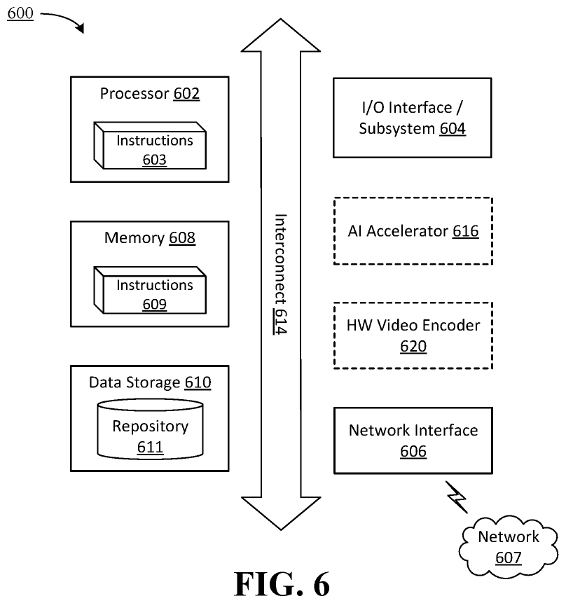

FIG. 6 is a block diagram illustrating an example of an architecture for a computing system 600 for use in AV1 video encoding according to one or more examples, with reference to components and features described herein including but not limited to the figures and associated description. In examples, the computing system 600 can be used to implement any of the devices, components, processes or features described herein, or portion(s) thereof, including the video distribution system 100 (FIG. 1), the video encoder 120 (FIG. 1), the mode decision process flow 300 (FIG. 3), the pruning techniques 401 (FIG. 4A), the pruning techniques 411 (FIG. 4B), the pruning techniques 421 (FIG. 4C), the pruning techniques 431 (FIG. 4D), the method 500 (FIG. 5) and/or any other components or features of the foregoing.

The computing system 600 includes one or more processors 602, an input-output (I/O) interface/subsystem 604, a network interface 606, a memory 608, and a data storage 610. These components are coupled or connected via an interconnect 614. Although FIG. 6 illustrates certain components, the computing system 600 can include additional or multiple components coupled or connected in various ways. It is understood that not all examples will necessarily include every component shown in FIG. 6.

The processor 602 can include one or more processing devices such as a microprocessor, a central processing unit (CPU), a fixed application-specific integrated circuit (ASIC) processor, a reduced instruction set computing (RISC) processor, a complex instruction set computing (CISC) processor, a field-programmable gate array (FPGA), a digital signal processor (DSP), etc., along with associated circuitry, logic, and/or interfaces. The processor 602 can include, or be connected to, a memory (such as, e.g., the memory 608) storing executable instructions 609 and/or data, as necessary or appropriate. The processor 602 can execute such instructions to implement, control, operate or interface with any devices, components, features or methods described herein including with reference to FIGS. 1, 3, 4A-4E, and 5. The processor 602 can communicate, send, or receive messages, requests, notifications, data, etc. to/from other devices. The processor 602 can be embodied as any type of processor capable of performing the functions described herein. For example, the processor 602 can be embodied as a single or multi-core processor(s), a digital signal processor, a microcontroller, or other processor or processing/controlling circuit. The processor can include embedded instructions 603 (e.g., processor code).

The I/O interface/subsystem 604 can include circuitry and/or components suitable to facilitate input/output operations with the processor 602, the memory 608, and other components of the computing system 600. The I/O interface/subsystem 604 can include a user interface including code to present, on a display, information or screens for a user and to receive input (including commands) from a user via an input device (e.g., keyboard or a touch-screen device).

The network interface 606 can include suitable logic, circuitry, and/or interfaces that transmits and receives data over one or more communication networks using one or more communication network protocols. The network interface 606 can operate under the control of the processor 602, and can transmit/receive various requests and messages to/from one or more other devices (such as, e.g., any one or more of the devices illustrated herein with reference to FIG. 1). The network interface 606 can include wired or wireless data communication capability; these capabilities can support data communication with a wired or wireless communication network, such as the network 607, and/or further including the Internet, a wide area network (WAN), a local area network (LAN), a wireless personal area network, a wide body area network, a cellular network, a telephone network, any other wired or wireless network for transmitting and receiving a data signal, or any combination thereof (including, e.g., a Wi-Fi network or corporate LAN). The network interface 606 can support communication via a short-range wireless communication field, such as Bluetooth, NFC, or RFID. Examples of network interface 606 can include, but are not limited to, an antenna, a radio frequency transceiver, a wireless transceiver, a Bluetooth transceiver, an ethernet port, a universal serial bus (USB) port, or any other device configured to transmit and receive data.

The memory 608 can include suitable logic, circuitry, and/or interfaces to store executable instructions and/or data, as necessary or appropriate, when executed, to implement, control, operate or interface with any devices, components, features or methods described herein with reference to FIGS. 1, 3, 4A-4E, and 5. The memory 608 can be embodied as any type of volatile or non-volatile memory or data storage capable of performing the functions described herein, and can include a random-access memory (RAM), a read-only memory (ROM), write-once read-multiple memory (e.g., EEPROM), a removable storage drive, a hard disk drive (HDD), a flash memory, a solid-state memory, and the like, and including any combination thereof. In operation, the memory 608 can store various data and software used during operation of the computing system 600 such as operating systems, applications, programs, libraries, and drivers. The memory 608 can be communicatively coupled to the processor 602 directly or via the I/O subsystem 604. In use, the memory 608 can contain, among other things, a set of machine instructions 609 which, when executed by the processor 602, causes the processor 602 to perform operations to implement examples of the present disclosure.

The data storage 610 can include any type of device or devices configured for short-term or long-term storage of data such as, for example, memory devices and circuits, memory cards, hard disk drives, solid-state drives, non-volatile flash memory, or other data storage devices. The data storage 610 can include or be configured as a database, such as a relational or non-relational database, or a combination of more than one database. In some examples, a database or other data storage can be physically separate and/or remote from the computing system 600, and/or can be located in another computing device, a database server, on a cloud-based platform, or in any storage device that is in data communication with the computing system 600. In examples, the data storage 610 includes a data repository 611, which in examples can include data for a specific application.

The interconnect 614 can include any one or more separate physical buses, point to point connections, or both connected by appropriate bridges, adapters, or controllers. The interconnect 614 can include, for example, a system bus, a Peripheral Component Interconnect (PCI) bus, a HyperTransport or industry standard architecture bus, a small computer system interface (SCSI) bus, a universal serial bus (USB), IIC (I2C) bus, or an Institute of Electrical and Electronics Engineers (IEEE) standard 694 bus (e.g., “Firewire”), or any other interconnect suitable for coupling or connecting the components of the computing system 600.

In some examples, the computing system 600 also includes an accelerator, such as an artificial intelligence (AI) accelerator 616. The AI accelerator 616 includes suitable logic, circuitry, and/or interfaces to accelerate artificial intelligence applications, such as, e.g., artificial neural networks, machine vision and machine learning applications, including through parallel processing techniques. In one or more examples, the AI accelerator 616 can include hardware logic or devices such as, e.g., a graphics processing unit (GPU) or an FPGA. The AI accelerator 616 can implement any one or more devices, components, features or methods described herein with reference to FIGS. 1, 3, 4A-4E, and 5.

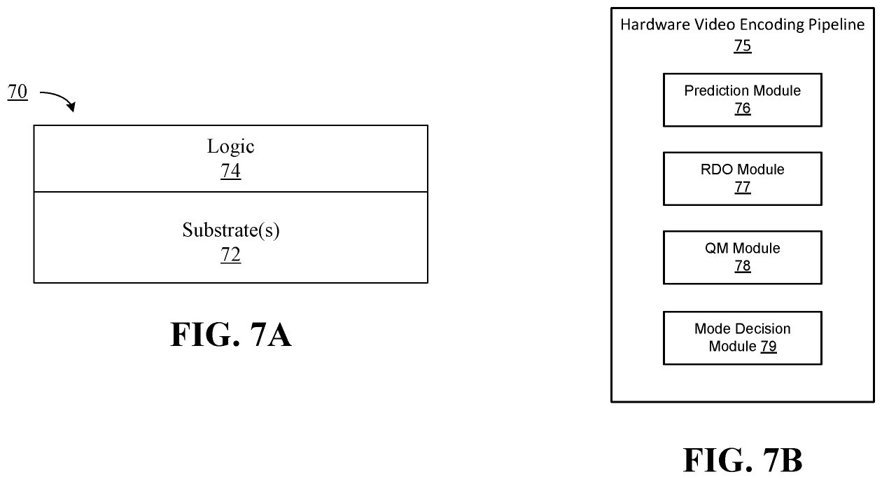

In some examples, the computing system 600 also includes a hardware video encoder 620. The hardware video encoder 620 encodes video according to a video encoding format, such as the AV1 video coding format. The hardware video encoder 620 can include or be part of a video codec such as, e.g., a codec conforming to the AV1 video coding format. The hardware video encoder 620 can implement any one or more devices, components, features or methods described herein with reference to FIGS. 1, 3, 4A-4E, and 5, including, for example, the video encoder 120 (FIG. 1). Further details regarding the hardware video encoder 620 are provided herein with reference to FIGS. 7A-7B.

In some examples, the computing system 600 also includes a display (not shown in FIG. 6). In some examples, the computing system 600 also interfaces with a separate display such as, e.g., a display installed in another connected device (not shown in FIG. 6). The display can be any type of device for presenting visual information, such as a computer monitor, a flat panel display, or a mobile device screen, and can include a liquid crystal display (LCD), a light-emitting diode (LED) display, a plasma panel, or a cathode ray tube display, etc. The display can include a display interface for communicating with the display. In some examples, the display can include a display interface for communicating with a display external to the computing system 600.

In some examples, one or more of the illustrative components of the computing system 600 can be incorporated (in whole or in part) within, or otherwise form a portion of, another component. For example, the memory 608, or portions thereof, can be incorporated within the processor 602. As another example, the I/O interface/subsystem 604 can be incorporated within the processor 602 and/or code (e.g., instructions 609) in the memory 608. In some examples, the computing system 600 can be embodied as, without limitation, a mobile computing device, a smartphone, a wearable computing device, an Internet-of-Things device, a laptop computer, a tablet computer, a notebook computer, a computer, a workstation, a server, a multiprocessor system, and/or a consumer electronic device.

In some examples, the computing system 600, or portion(s) thereof, is/are implemented in one or more modules as a set of logic instructions stored in at least one non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

FIGS. 7A-7B provide block diagrams illustrating a semiconductor apparatus 70 for AV1 video encoding according to one or more examples, with reference to components and features described herein including but not limited to the figures and associated description. Turning to FIG. 7A, shown is a semiconductor apparatus 70 which can be implemented, e.g., as a chip, die, or other semiconductor package. The semiconductor apparatus 70 can include one or more substrates 72 comprised of, e.g., silicon, sapphire, gallium arsenide, etc. The semiconductor apparatus 70 can also include logic 74 comprised of, e.g., transistor array(s) and other integrated circuit (IC) components) coupled to the substrate(s) 72. For example, the logic 74 can include circuitry positioned on and/or embedded within the substrate(s) 72. The logic 74 can be implemented at least partly in configurable logic or fixed-functionality logic hardware. The logic 74 can implement portions or all of the computing system 600 described above with reference to FIG. 6, including the hardware video encoder 620. The logic 74 can implement one or more aspects of the processes described above, including the method 500 and including processes described herein with reference to FIGS. 1, 3, 4A-4E, and 5. The logic 74 can implement one or more aspects of the video distribution system system 100 or the video encoder 120 as described herein with reference to FIG. 1.

The semiconductor apparatus 70 can be constructed using any appropriate semiconductor manufacturing processes or techniques.

Turning now to FIG. 7B, illustrated is an example of a hardware video encoding pipeline 75. The hardware video encoding pipeline 75 can be implemented via hardware logic as part of a semiconductor apparatus, such as logic 74 in the semiconductor apparatus 70 (FIG. 7A). The hardware video encoding pipeline 75 includes a prediction module 76, an RDO module 77, and a mode decision module 79. In some examples the hardware video encoding pipeline 75 also includes a quality metric (QM) module 78. The prediction module 76 is configured to select prediction modes and/or generate encodes of video data in accordance with selected prediction modes. The RDO module 77 is configured to determine costs (e.g., a rate-distortion cost) associated with encoding video data in accordance with a selected prediction mode. The QM module 78 can be configured to determine one or more quality metrics associated with encodes of video data. The mode decision module 79 is configured to select a prediction mode from a plurality of prediction modes based on costs and (when the QM module is present) quality metrics associated with the prediction modes.

Examples of each of the above systems, devices, components, features and/or methods, including the video distribution system 100 (FIG. 1), the video encoder 120 (FIG. 1), the mode decision process flow 300 (FIG. 3), the pruning techniques 401 (FIG. 4A), the pruning techniques 411 (FIG. 4B), the pruning techniques 421 (FIG. 4C), the pruning techniques 431 (FIG. 4D), the method 500 (FIG. 5), and/or any other system components, can be implemented in hardware, software, or any suitable combination thereof. For example, hardware implementations can include configurable logic, fixed-functionality logic, or any combination thereof. Examples of configurable logic include suitably configured PLAs, FPGAs, CPLDS, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

Alternatively, or additionally, all or portions of the foregoing systems, devices, components, features and/or methods can be implemented in one or more modules as a set of program or logic instructions stored in a machine- or computer-readable storage medium such as RAM, ROM, PROM, firmware, flash memory, etc., to be executed by a processor or computing device. For example, computer program code to carry out the operations of the components can be written in any combination of one or more operating system (OS) applicable/appropriate programming languages, including an object-oriented programming language such as Java, JavaScript, Python C#, C++, Perl, Smalltalk, or the like and conventional procedural programming languages, such as the “C” programming language or similar programming languages.

### Additional Notes and Examples

Example M1 includes a method of video encoding comprising pruning interframe candidate modes, based on one or more criteria, to provide a reduced set of candidate modes for encoding a video block, wherein a candidate mode includes an interframe mode type, a set of reference frame types, and one or more dynamic reference list (DRL) candidates, and wherein pruning interframe candidate modes comprises excluding one or more interframe mode types, determining a rate distortion (RD) cost for each of the candidate modes in the reduced set of candidate modes, selecting a candidate mode from the reduced set of candidate modes, based on the lowest RD cost, as a selected interframe mode, and encoding the video block using the selected interframe mode.

Example M2 includes the method of Example M1, wherein pruning the interframe candidate modes further comprises one or more of reducing a number of reference frame types or reducing a number of DRL candidates.

Example M3 includes the method of Example M1 or M2, wherein pruning the interframe candidate modes comprises excluding at least one interframe mode type based on an ordered list of interframe mode types.

Example M4 includes the method of any of Examples M1-M3, wherein pruning the interframe candidate modes comprises one or more of excluding at least one interframe mode type or reducing a number of DRL candidates based on a difference between two motion vectors.

Example M5 includes the method of any of Examples M1-M4, wherein pruning the interframe candidate modes comprises excluding at least one interframe mode type based on a difference between a source for the video block and a prediction for the video block, wherein the prediction is based on a respective interframe mode type.

Example M6 includes the method of any of Examples M1-M5, wherein pruning the interframe candidate modes comprises excluding at least one interframe mode type based on one or more of RD costs for single-reference interframe candidate modes or block size for the video block.

Example M7 includes the method of any of Examples M1-M6, wherein pruning the interframe candidate modes further comprises reducing a number of combinations based on a cost metric from fractional motion estimation.

Example M8 includes the method of any of Examples M1-M7, wherein pruning the interframe candidate modes further comprises bypassing an interpolation filter selection stage and using a predetermined filter.

Example A1 includes a video encoding apparatus comprising a memory to store a video block, and logic communicatively coupled to the memory, the logic implemented at least partly in one or more of configurable hardware logic or fixed-functionality hardware logic, the logic to perform operations comprising pruning interframe candidate modes, based on one or more criteria, to provide a reduced set of candidate modes for encoding the video block, wherein a candidate mode includes an interframe mode type, a set of reference frame types, and one or more dynamic reference list (DRL) candidates, and wherein pruning interframe candidate modes comprises excluding one or more interframe mode types, determining a rate distortion (RD) cost for each of the candidate modes in the reduced set of candidate modes, selecting a candidate mode from the reduced set of candidate modes, based on the lowest RD cost, as a selected interframe mode, and encoding the video block using the selected interframe mode.

Example A2 includes the video encoding apparatus of Example A1, wherein pruning the interframe candidate modes further comprises one or more of reducing a number of reference frame types or reducing a number of DRL candidates.

Example A3 includes the video encoding apparatus of Example A1 or A2, wherein pruning the interframe candidate modes comprises excluding at least one interframe mode type based on an ordered list of interframe mode types.

Example A4 includes the video encoding apparatus of any of Examples A1-A3, wherein pruning the interframe candidate modes comprises one or more of excluding at least one interframe mode type or reducing a number of DRL candidates based on a difference between two motion vectors.

Example A5 includes the video encoding apparatus of any of Examples A1-A4, wherein pruning the interframe candidate modes comprises excluding at least one interframe mode type based on a difference between a source for the video block and a prediction for the video block, wherein the prediction is based on a respective interframe mode type.

Example A6 includes the video encoding apparatus of any of Examples A1-A5, wherein pruning the interframe candidate modes comprises excluding at least one interframe mode type based on one or more of RD costs for single-reference interframe candidate modes or block size for the video block.

Example A7 includes the video encoding apparatus of any of Examples A1-A6, wherein pruning the interframe candidate modes further comprises reducing a number of combinations based on a cost metric from fractional motion estimation.

Example A8 includes the video encoding apparatus of any of Examples A1-A7, wherein pruning the interframe candidate modes further comprises bypassing an interpolation filter selection stage and using a predetermined filter.

Example C1 includes at least one computer readable storage medium comprising a set of instructions which, when executed by a computing device, cause the computing device to perform operations comprising pruning interframe candidate modes, based on one or more criteria, to provide a reduced set of candidate modes for encoding a video block, wherein a candidate mode includes an interframe mode type, a set of reference frame types, and one or more dynamic reference list (DRL) candidates, and wherein pruning interframe candidate modes comprises excluding one or more interframe mode types, determining a rate distortion (RD) cost for each of the candidate modes in the reduced set of candidate modes, selecting a candidate mode from the reduced set of candidate modes, based on the lowest RD cost, as a selected interframe mode, and encoding the video block using the selected interframe mode.

Example C2 includes the at least one computer readable storage medium of Example C1, wherein pruning the interframe candidate modes further comprises one or more of reducing a number of reference frame types or reducing a number of DRL candidates.

Example C3 includes the at least one computer readable storage medium of Example C1 or C2, wherein pruning the interframe candidate modes comprises excluding at least one interframe mode type based on an ordered list of interframe mode types.

Example C4 includes the at least one computer readable storage medium of any of Examples C₁-C₃, wherein pruning the interframe candidate modes comprises one or more of excluding at least one interframe mode type or reducing a number of DRL candidates based on a difference between two motion vectors.

Example C5 includes the at least one computer readable storage medium of any of Examples C1-C4, wherein pruning the interframe candidate modes comprises excluding at least one interframe mode type based on a difference between a source for the video block and a prediction for the video block, wherein the prediction is based on a respective interframe mode type.

Example C6 includes the at least one computer readable storage medium of any of Examples C1-C5, wherein pruning the interframe candidate modes comprises excluding at least one interframe mode type based on one or more of RD costs for single-reference interframe candidate modes or block size for the video block.

Example C7 includes the at least one computer readable storage medium of any of Examples C1-C6, wherein pruning the interframe candidate modes further comprises reducing a number of combinations based on a cost metric from fractional motion estimation.

Example C8 includes the at least one computer readable storage medium of any of Examples C1-C7, wherein pruning the interframe candidate modes further comprises bypassing an interpolation filter selection stage and using a predetermined filter.

Example R1 includes an apparatus comprising means for performing the method of any of Examples M1 to M8.

Examples are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary examples to facilitate casier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although examples are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the examples. Further, arrangements may be shown in block diagram form in order to avoid obscuring examples, and also in view of the fact that specifics with respect to implementation of such block diagram arrangements are highly dependent upon the platform within which the example is to be implemented, i.e., such specifics should be well within purview of one skilled in the art. Where specific details (e.g., circuits) are set forth in order to describe examples, it should be apparent to one skilled in the art that examples can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the examples can be implemented in a variety of forms. Therefore, while the technology has been described in connection with particular examples thereof, the true scope of the examples should not be so limited since other modifications will become apparent to the skilled practitioner upon a study of the drawings, specification, and following claims.

We claim:

1. A method of video encoding comprising:
pruning interframe candidate modes, based on one or more criteria, to provide a reduced set of candidate modes for encoding a video block,
wherein a candidate mode includes an interframe mode type, a set of reference frame types, and one or more dynamic reference list (DRL) candidates, and
wherein pruning interframe candidate modes comprises excluding one or more interframe mode types;
determining a rate distortion (RD) cost for each of the candidate modes in the reduced set of candidate modes;
selecting a candidate mode from the reduced set of candidate modes, based on the lowest RD cost, as a selected interframe mode; and
encoding the video block using the selected interframe mode.

2. The method of claim 1, wherein pruning the interframe candidate modes further comprises one or more of reducing a number of reference frame types or reducing a number of DRL candidates.

3. The method of claim 1, wherein pruning the interframe candidate modes comprises excluding at least one interframe mode type based on an ordered list of interframe mode types.

4. The method of claim 1, wherein pruning the interframe candidate modes comprises one or more of excluding at least one interframe mode type or reducing a number of DRL candidates based on a difference between two motion vectors.

5. The method of claim 1, wherein pruning the interframe candidate modes comprises excluding at least one interframe mode type based on a difference between a source for the video block and a prediction for the video block, wherein the prediction is based on a respective interframe mode type.

6. The method of claim 1, wherein pruning the interframe candidate modes comprises excluding at least one interframe mode type based on one or more of RD costs for single-reference interframe candidate modes or block size for the video block.

7. The method of claim 1, wherein pruning the interframe candidate modes further comprises reducing a number of combinations based on a cost metric from fractional motion estimation.

8. The method of claim 1, wherein pruning the interframe candidate modes further comprises bypassing an interpolation filter selection stage and using a predetermined filter.

9. A video encoding apparatus comprising:
a memory to store a video block; and
logic communicatively coupled to the memory, the logic implemented at least partly in one or more of configurable hardware logic or fixed-functionality hardware logic, the logic to perform operations comprising:
pruning interframe candidate modes, based on one or more criteria, to provide a reduced set of candidate modes for encoding the video block,
wherein a candidate mode includes an interframe mode type, a set of reference frame types, and one or more dynamic reference list (DRL) candidates, and
wherein pruning interframe candidate modes comprises excluding one or more interframe mode types;
determining a rate distortion (RD) cost for each of the candidate modes in the reduced set of candidate modes;
selecting a candidate mode from the reduced set of candidate modes, based on the lowest RD cost, as a selected interframe mode; and
encoding the video block using the selected interframe mode.

10. The video encoding apparatus of claim 9, wherein pruning the interframe candidate modes further comprises one or more of reducing a number of reference frame types or reducing a number of DRL candidates.

11. The video encoding apparatus of claim 9, wherein pruning the interframe candidate modes comprises excluding at least one interframe mode type based on an ordered list of interframe mode types.

12. The video encoding apparatus of claim 9, wherein pruning the interframe candidate modes comprises one or more of excluding at least one interframe mode type or reducing a number of DRL candidates based on a difference between two motion vectors.

13. The video encoding apparatus of claim 9, wherein pruning the interframe candidate modes comprises excluding at least one interframe mode type based on a difference between a source for the video block and a prediction for the video block, wherein the prediction is based on a respective interframe mode type.

14. The video encoding apparatus of claim 9, wherein pruning the interframe candidate modes comprises excluding at least one interframe mode type based on one or more of RD costs for single-reference interframe candidate modes or block size for the video block.

15. At least one computer readable storage medium comprising a set of instructions which, when executed by a computing device, cause the computing device to perform operations comprising:
pruning interframe candidate modes, based on one or more criteria, to provide a reduced set of candidate modes for encoding a video block,
wherein a candidate mode includes an interframe mode type, a set of reference frame types, and one or more dynamic reference list (DRL) candidates, and
wherein pruning interframe candidate modes comprises excluding one or more interframe mode types;
determining a rate distortion (RD) cost for each of the candidate modes in the reduced set of candidate modes;
selecting a candidate mode from the reduced set of candidate modes, based on the lowest RD cost, as a selected interframe mode; and
encoding the video block using the selected interframe mode.

16. The at least one computer readable storage medium of claim 15, wherein pruning the interframe candidate modes further comprises one or more of reducing a number of reference frame types or reducing a number of DRL candidates.

17. The at least one computer readable storage medium of claim 15, wherein pruning the interframe candidate modes comprises excluding at least one interframe mode type based on an ordered list of interframe mode types.

18. The at least one computer readable storage medium of claim 15, wherein pruning the interframe candidate modes comprises one or more of excluding at least one interframe mode type or reducing a number of DRL candidates based on a difference between two motion vectors.

19. The at least one computer readable storage medium of claim 15, wherein pruning the interframe candidate modes comprises excluding at least one interframe mode type based on a difference between a source for the video block and a prediction for the video block, wherein the prediction is based on a respective interframe mode type.

20. The at least one computer readable storage medium of claim 15, wherein pruning the interframe candidate modes comprises excluding at least one interframe mode type based on one or more of RD costs for single-reference interframe candidate modes or block size for the video block.
